(19) United States
(12) Patent Application Publication
(10) Pub. No.: US 2007/0065655 A1
(43) Pub. Date: Mar. 22, 2007

(54) Flame retardant porous film

(76) Inventors: Robert M. Floyd, Maplewood, MN (US); James S. Mrozinski, Oakdale, MN (US)

Correspondence Address: 3M INNOVATIVE PROPERTIES COMPANY, PO BOX 33427, ST. PAUL, MN, 55133-3427, US

(21) Appl. No.: 11/229,963

(22) Filed: Sep. 19, 2005

(51) Int. Cl. B32B 5/22; C08J 9/26

(52) U.S. Cl. 428/317.9; 521/61; 521/63

(57) ABSTRACT

The present invention is a microporous film that includes a crystallizable polymer, a melting flame retardant additive, a non-melting nucleating agent, and a diluent.

### BACKGROUND OF THE INVENTION

Microporous films or membranes have been used in a wide variety of applications, such as for the filtration of solids, for the ultrafiltration of colloidal matter, as diffusion barriers or separators in electrochemical cells, in the preparation of synthetic leather, and in the preparation of cloth laminates. Some of these applications require permeability to water vapor but not liquid water, such as when using the materials for synthetic shoes, raincoats, outerwear, camping equipment such as tents, and the like. Microporous films are often utilized for microfiltration of liquids such as antibiotics, beer, oils, bacteriological broths, as well as for the analysis of air, microbiological samples, intravenous fluids, vaccines, and the like. Microporous films are also utilized in the preparation of surgical dressings, bandages, and in other fluid or gas transmissive medical applications.

Microporous films have structures that enable fluids (gas, and often liquids) to flow through them or into them. Whether or not liquid will pass through the film is dependent upon the pore size of the structure and many other properties such as surface energy and chemical nature. Such films are generally opaque, even when made from an originally transparent material, because the surfaces and internal structure scatter visible light.

Microporous films may also be laminated to other films to make laminates having particular utility. Such laminates may include a microporous layer and an outer shell layer to provide a garment material. Further, the microporous films may be utilized as tape backings to provide such products as vapor transmissive wound dressings or hair setting tapes.

The art is replete with various methods of producing microporous materials. One useful technology is thermally induced phase separation (TIPS). The TIPS process is based on the use of a polymer that is soluble in a diluent at an elevated temperature and insoluble in the diluent at a relatively lower temperature. The “phase separation” can involve a solid-liquid phase separation, or a liquid-liquid phase separation. This technology has been employed in the preparation of microporous materials wherein thermoplastic polymer and diluent are separated by liquid-liquid phase separation as described in U.S. Pat. Nos. 4,247,498 and 4,867,881. A solid-liquid phase separation has been described in U.S. Pat. No. 4,539,256 wherein the thermoplastic polymer crystallizes out on cooling. The use of nucleating agents incorporated in the microporous material is also described as an improvement in the solid-liquid phase separation method described in U.S. Pat. No. 4,726,989.

### BRIEF SUMMARY OF THE INVENTION

The present invention is a composition that includes a crystallizable polymer, a melting flame retardant additive, a non-melting nucleating agent, and a diluent.

In one embodiment, the present invention is characterized as a microporous film comprised of the composition stated above.

The above summary is not intended to describe each disclosed embodiment of every implementation of the present invention. The figure and detailed description that follow more particularly exemplify illustrative embodiments.

### DETAILED DESCRIPTION

The microporous film of the present invention includes a crystallizable polymer, a melting flame retardant additive, a non-melting nucleating agent, and a diluent. The term “melting” refers to the temperature at which the flame material, whether the flame retardant additive or nucleating agent, or combination thereof, will melt. The microporous film of the present invention may be employed in any of a wide variety of situations wherein microporous structures are utilized. The films are especially useful in applications where there is a possibility of exposure to heat or an ignition source. By incorporating flame retardant additives into a microporous film, porous films are provided which are difficult to ignite, which propagate flame much more slowly and which may be self-extinguishing. Such applications include clothing, wall, or roofing barriers (such as moisture vapor transmission barriers), optical films in electronic devices (such as reflective and dispersive films), printing substrates, and electrical insulation.

The melting flame retardant additive is environmentally friendly due to its low bromine concentration in the finished product and is easier to manufacture than its non-melting counterparts. Using a melting flame retardant additive results in minimal build-up of bromine on the extruder filter, leading to extended extruder filter life. A non-melting flame retardant additive will typically plug the extruder filter within only about four hours of using the extruder filter. By contrast, a melting flame retardant additive has virtually no effect on extruder filter life.

All concentrations herein are expressed in weight percent, unless otherwise stated. Suitable component concentrations in the flame retardant microporous film of the present invention range from about 40% to about 75% polymer, about 1% to about 20% melting flame retardant additive, about 0.01% to about 5.0% non-melting nucleating agent, and about 25% to about 60% diluent, based on the total compositional weight of the composition of the present invention. Particularly suitable component concentrations in the composition of the present invention range from about 50% to about 70% polymer, about 2% to about 6% melting flame retardant additive, and about 0.2% to about 1.0% non-melting nucleating agent, and about 35% to about 45% diluent, based on the total compositional weight of the composition of the present invention. Those skilled in the art will appreciate suitable component concentration ranges for obtaining comparable physical properties of the manufactured films.

Crystallizable polymers suitable for use in the preparation of the microporous film of the present invention are well known and readily commercially available. The useful polymers are melt processable under conventional processing conditions. That is, on heating they will easily soften and/or melt to permit processing in conventional equipment such as an extruder to form a sheet.

Examples of suitable polymers for the present invention include the polymers of ethylene and propylene but may also include methylpentene, butane, 1-octene, styrene, and the like, and copolymers of two or more such olefins that may be polymerized to contain crystalline and amorphous segments and mixtures of stereo-specific modification of such polymers (e.g., mixtures of isotactic polypropylene and atactic polypropylene). An example of a particularly suitable polymer is polypropylene. An example of a particularly suitable commercially available polypropylene is 51S07A, available from Sunoco Chemical, Pittsburgh, PA.

In general, flame retardant additives preferably form a homogenous mixture (dispersion or solution) with the polymer and diluent components at the processing temperatures used, and may melt above or below the processing temperature. In order that the flame retardant additive not weaken the structure of the ultimate article (such as a film or sheet), the additive should not inhibit the crystal nucleation of the polymer component during phase separation such that any microstructures that may form grow so large as to adversely weaken the film.

Examples of suitable flame retardant additives for the present invention are added to or incorporated into the polymeric matrix of the microporous film in sufficient amounts to render an otherwise flammable polymer flame retardant, as measured by the Underwriters Laboratory Horizontal Burn test (UL 94 HB), the Deutsches Institut für Normung Vertical Burn test (DIN 4102 B2) and/or the Federal Motor Vehicle Safety Standard 302. An example of a particularly suitable commercially available melting flame 3retardant additive is PE-68, available from Great Lakes Chemicals, Indianapolis, Ind.

Nucleating agents are materials that may be added to the polymer melt as a foreign body. When the polymer cools from the polymer melt to its crystallization temperature range, the loosely coiled polymer chains orient themselves about the foreign body into regions of a three-dimensional crystal pattern to form a material having a continuous polymer phase and a diluent phase. Nucleating agents work in the presence of melt additives in the thermally induced phase separated system of the present invention. The presence of at least one nucleating agent is advantageous during the crystallization of certain polymeric materials, such as polypropylene, by substantially accelerating the crystallization of the polymer, due to the increased number of crystallization sites, over that occurring when no nucleating agent is present. This in turn results in a film with a more uniform, stronger microstructure because of the presence of an increased number of reduced-sized domains connected to one another by a network of tie fibrils. The smaller, more uniform microstructure has an increased number of fibrils per unit volume and allows for greater stretchability of the materials so as to provide higher void porosity and greater tensile strength than heretofore achievable. Additional details regarding the use of nucleating agents are discussed, for example, in U.S. Pat. No. 6,632,850 and in U.S. Pat. No. 4,726,989.

The nucleating agent should be selected based on the polymer being used. The nucleating agent serves the important functions of inducing crystallization of the polymer from the liquid state and enhancing the initiation of polymer crystallization sites so as to speed up the crystallization of the polymer. Thus, the nucleating agent may be a solid at the crystallization temperature of the polymer. Because the nucleating agent increases the rate of crystallization of the polymer by providing nucleation sites, the size of the resultant polymer domains or spherulites is reduced. When the nucleating agent is used to form the microporous materials of the present invention, greater amounts of diluent compound can be used relative to the polymer forming the microporous materials.

By including a nucleating agent, the resultant domains of olefin-containing polymer are reduced in size over the size the domains would have if no nucleating agent were used. It will be understood, however, that the domain size obtained will depend upon the additive, component concentrations, and processing conditions used. Because reduction in domain size results in more domains, the number of fibrils per unit volume is also increased. Moreover, after stretching, the length of the fibrils may be increased when a nucleating agent is used than when no nucleating agent is used because of the greater stretchability that can be achieved. Similarly, the tensile strength of the resultant microporous materials can be greatly increased. Hence, by including a nucleating agent, more useful microporous materials can be prepared than when nucleating agents are not present.

Examples of a suitable nucleating agent are non-melting nucleating agents and various colored pigments. A particularly suitable commercially available non-melting nucleating agent is HPN-68, available from Milliken Chemical, Spartanburg, S.C. Examples of particularly suitable commercially available colored pigments are trade names Blue APY 5014A and PV-19 E4B, both available from Clariant Corporation, Milford, Del.

A diluent component must also be used for blending with the crystallizable polymer to make the microporous film of the invention. The diluent component is a liquid at room temperature in which the crystallizable polymer will dissolve to form a solution at the melting temperature and in which the crystallizable polymer will phase separate on cooling at or below the crystallization temperature of the crystallizable polymer. Preferably, these compounds have a boiling point at atmospheric pressure at least as high as the melting temperature of the crystallizable polymer. Compounds having lower boiling points may be used in those instances where superatmospheric pressure may be employed to elevate the boiling point of the compound to a temperature at least as high as the melting temperature of the crystallizable polymer. Generally, suitable diluent components have a solubility parameter and a hydrogen bonding parameter within a few units of the values of these parameters for the crystallizable polymer.

Examples of suitable diluents are those that form solutions with the polymer component at elevated temperatures and phase separate upon cooling and include organic compounds of paraffinic (alkane) acids and various hydrocarbons. Examples of particularly suitable diluents are phthalates, such as dioctyl-, diethyl-, and dibutyl-; mineral oil; and mineral spirits. An example of a particularly suitable diluent is mineral oil. An example of a particularly suitable commercially available diluent is trade name Mineral Oil Superla White No. 31, available from Chevron, San Ramon, Calif.

The microporous film of the present invention may also include additional components in varying concentrations as individual needs may require. For example, the microporous film of the present invention may further include coloring agents, ultraviolet light stabilizers, antioxidants, processing aids, fiberglass, mineral fillers, anti-slip agents, plasticizers, reinforcing agents, and combinations thereof. An example of a particularly suitable commercially available additive is trade name Antioxidant Irganox 1010, available from Ciba Specialty Chemicals, Tarrytown, N.Y.

The microporous film of the present invention may be made by using a mixing and extruding process. A microporous film according to the invention is made by first preparing a melt solution by mixing the polymer component, the diluent component, the flame retardant additive, and the nucleating agent under agitation such as that provided by an extruder and heating until the temperature of the mixture is above the liquid-solid phase separation temperature. At this point the mixture becomes a melt solution or single phase, except for the nucleating agent, which exists as a uniformly dispersed particulate. Once the melt solution is prepared, a shaped film is then formed by known methods, for example, employing an extruder.

The preferred film according to the present invention is in the form of a sheet or film although other film shapes are contemplated. For example, the film may be in the form of a tube or filament. Other shapes that can be made according to the disclosed process are intended to be within the scope of the invention.

Cooling of the shaped film occurs either in the extruder, at or near the die at the extruder discharge, or preferably by casting the shaped material onto a chill roll. The microporous films of the present invention are typically cooled by casting on a patterned drum. Protrusions in the pattern result in less contact between the metal cooling drum and the hot solution (or melt); thus slowing the cooling when compared to that observed with a smooth (non-patterned) drum. Cooling causes the phase transition to occur between the diluent and the polymer components. This occurs by crystallization precipitation of the polymer component to form a network of polymer domains.

The shaped material (e.g., oil-in cast film) is nonporous at this stage and is rendered microporous by orientation (stretching), diluent removal, or a combination thereof. The stretching is at least in one direction to separate adjacent crystallized polymer domains from one another to provide a network of interconnected micropores. Stretching may be achieved by pulling the films with either a length orienter and/or tenter (i.e., orienting down-web, cross-web, or both). When the film is pulled in more than one direction, the degree of stretch may be the same or different in each direction.

The film formed from liquid-solid phase separation, before orientation, is solid and generally transparent comprising an aggregate of a first phase or spherulites of crystallized thermoplastic polymer and second phase of the diluent component. Independently, the flame retardant additive may be dissolved in the polymer component and/or diluent component or may form a third phase(s) of flame retardant additive dispersed in the matrix as a solid or liquid. The polymer domains may be described as spherulites and aggregates of spherulites of the polymer. Adjacent domains of polymer are distinct but they have a plurality of zones of continuity. That is, the polymer domains are generally surrounded or coated by the diluent component, but not completely. There are areas of contact between adjacent polymer domains where phase separation has not occurred and there is a continuum of polymer from one domain to the next adjacent domain in such zones of continuity.

On orienting or stretching, the polymer domains are pulled part, permanently attenuating the polymer in the zones of continuity thereby forming fibrils that interconnect the polymer spherulites, and forming minute voids between coated particles, creating a network of interconnected micropores, thereby rendering the film permanently translucent. On orienting or stretching, the diluent component remains coated on or surrounds, at least partially, the surfaces of the resultant thermoplastic polymer domains. The degree of coating depends upon the affinity of the diluent for the surface of the polymer domain, whether the diluent is liquid or solid, whether orientation dislodges or disrupts the coating, and on other factors which may be relevant. The domains are usually at least partially coated after orientation. Substantially all of the domains appear to be connected by fibrils. The size of the micropores is controlled by varying the degree of stretching, percent of diluent, flame retardant additive, nucleating agent components, melt-quench conditions, diluent removal, and heat-stabilization procedures. The fibrils for the most part do not appear to be broken by stretching but they are permanently stretched beyond their elastic limit so that they do not elastically recover to their original position when the stretching force is released. As used herein, “orienting” means such stretching beyond the elastic limit so as to introduce permanent set or elongation of the film. Stretching below the elastic limit is also effective if the film is annealed or heat-set while under tension.

An extruder with either a blown film die or a cast film die and a chill roll can be used to initiate the thermal phase separation process as described above. These resulting films can be washed and/or stretch oriented in either a uniaxial or biaxial manner to yield a microporous film. Further, the oriented films may be annealed or heat-set to retain the orientation imparted. These microporous films are both porous and breathable as demonstrated by air-flow/Gurley values between approximately 10 seconds/50 cubic centimeter (sec/cc) to 400 sec/50 cc. The films are thus suitable for many breathable garment and barrier film applications.

The microporous film according to the invention may be formed by extrusion followed by cooling to cause phase separation and then orientation to form a porous film structure. The temperatures and other process conditions depend on the type of materials used and the properties desired, and are known or readily determined by those in the art.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

The following test methods were used to characterize the films produced in the examples:

Mullens Burst Test

This test is a measurement of pressure in pounds per square inch (psi) that it takes to pass water through a porous material according to Federal Standard 191, Method 5512. Values greater than or equal to 25 psi are considered waterproof.

Gurley Air Flow This test is a measurement of time in seconds required to pass 50 cc of air through a film according to ASTM D-726 Method B. Generally, values from 1 to 400 seconds indicate good breathability.

Horizontal Burn

Burning characteristics of the films were evaluated according to the horizontal burn test Federal Motor Vehicle Safety Standard 571.302, Flammability of Interior Materials. Film samples were cut into strips having a width of 102 millimeters (mm) and a length of 356 mm. Two strips were cut in the machine direction of the film and tested. Each strip was mounted in a U-shaped support fixture (51 mm wide by 330 mm long, interior dimensions) and held in a horizontal position so that the bottom edge of the open end of the specimen was located 19 mm above the center of a Bunsen burner tip. The burner flame was set to 38 mm with the air inlet to the burner closed. The flame was slid into the open edge of the sample and applied for 15 seconds. If the flame front reached a point 38 mm from the open end of the specimen, a timer was started. The time for the flame to reach a point 38 mm from the clamped end of the specimen was recorded. If the flame did not reach the specified end point, the time was recorded at the point when flaming stopped. The burn rate was calculated from the average of the two test strips. The material was considered to have passed the 571.302 standard if (a) the burn rate did not exceed 102 mm per minute or (b) the material stopped burning before it has burned for 60 seconds from the start of timing and had not burned more than 51 mm from the point where the timing was started.

Materials Used

Polypropylene: melt flow index of 0.80 dg/min (ASTM D1238, Condition I) available from Sunoco Chemical as 51S07A, Pittsburgh, Pa.
PE-68: Tetrabromobisphenyl A bis (2,3-dibromoprpyl ether), available from Great Lakes Chemical Corp., Indianapolis, Ind.
CN-2923: 60% PE-68 in 40% ethylene ethyl acrylate copolymer (EEA), available from Great Lakes Chemical Corp., Indianapolis, Ind.
Milliken's HPN-68: Nucleating agent, available in pure powder form or as a 5% concentrate in polypropylene as HYPERFORM HI5-5, from Milliken Chemical Co., Inman, S.C.
Remafin Blue Pigment concentrate (Blue APY 5014A): C.I. 15:3 blue pigment dispersed at 40% in a PP resin, available from Clariant Corp., Milford, Del.
Irganox 1010: a high molecular weight thermal antioxidant stabilizer for PP resin, available from Ciba Specialty Chemicals, Tarrytown, N.Y.
PV-19 E4B: a Quinacridone red pigment available in a 0.25% concentrate PP resin, available from Clariant Corporation, Milford, Del.
Mineral oil: A transparent oil, having a viscosity of 100 centistokes (ASTM D445 at 40° C.) and an index of refraction of 1.48, available as Mineral Oil Superla White no. 31 from Chevron, San Ramon, Calif.

The following compositional abbreviation is used in the following Examples:
“PP”: A polypropylene, commercially available under the trade designation 51S07A from Sunoco Chemical, Pittsburgh, Pa.

### Example 1 and Comparative Example A

Example 1 is a microporous film of the present invention, with component concentrations (in weight percent) of polypropylene, Remafin Blue Pigment concentrate containing pure phthalo blue pigment, mineral oil, and CN-2923 containing flame retardant additive as provided in Table 1. Comparative Example A is a comparative composition, with component concentrations (in weight percent) of polypropylene, pure phthalo blue pigment, and mineral oil.

Polypropylene and blue pigment concentrate were fed into the hopper of a 25 millimeter (mm) twin-screw extruder. A mixture of mineral oil and PE-68 was pumped through a mass flowmeter and introduced into the extruder through an injection port in the second zone of the extruder. The composition was rapidly heated to 260° C. in the extruder to melt mix the components at 150 revolutions per minute (rpm) screw speed after which the temperature was cooled down to and maintained at 204° C. through the remainder of the extruder barrel. The molten composition was pumped from the extruder, through a filter, into a melt pump with a flow rate of 3.63 kilograms/hour (kg/hr), and then via a necktube into and through a coat hanger slit die and cast onto a chrome chill roll (66° C.) running at 2.1 meters/min. The chrome roll had a knurled pattern on it consisting of 40 raised truncated pyramids per centimeter both axially and radially. A roll of cast film was saved and biaxial stretched off-line 1.7×1.7 using a length orienter maintained at 66° C. and a tenter/stretching oven maintained at 116° C.

Comparative Example A was prepared as in Example 1, except that no PE-68 was added to the composition and the PP was increased such that it was a greater percentage of the total composition. Table 1 provides the microporous film concentrations, Mullens Burst pressure, Gurley values, and horizontal burn test results, as analyzed pursuant to the method discussed above, for films formed from the compositions of Example 1 and Comparative Example A.

TABLE 1

| | Phthalo Blue as Nucleating Agent | | | | | | |
|---|---|---|---|---|---|---|---|
| | | Mineral | PE-68, | Phthalo Blue, wt % | Mullens | Gurley values | Horz. Burn |
| Ex. | PP, wt % | Oil, wt % | wt % | (Blue APY 5014A, wt %) | Burst, psi | (sec/50 cc) | (no. passed) |
| 1 | 58.75 | 37.00 | 2.00 | 0.90 (2.25) | 60.0 | 13.0 | 5 of 6 |
| A | 60.75 | 37.00 | 0.00 | 0.90 (2.25) | 60.0 | 16.0 | 0 of 6 |

The data provided in Table 1 illustrates waterproof property, breathability, and good flame retardancy exhibited by films formed from the composition of the present invention. In particular, the film formed from the composition of Example 1 had a Mullens Burst value of 60 psi and Gurley resistance to airflow of 13 sec/50 cc. The film passed the horizontal burn test 5 out of 6 times. The Gurley resistance and Mullens Burst values indicate that the film formed from the composition of the present invention has porosity that allows the film to breathe while preventing water from passing through the film. The horizontal burn test indicates the film's low level of flammability.

As can be seen in Table 1, while the waterproof property and breathability of the film of Comparative Example A did not vary greatly from Example 1, the flammability of the films were greatly affected by the amount of flame retardant present in the formulation. Comparative Example A, which did not comprise any flame retardant additive, did not pass any of the horizontal burn tests. Comparatively, Example 1 had a total pass rate of 5 out of 6.

### Example 2 and Comparative Example B

Microporous films were prepared as in Example 1 and Comparative Example A, except that PV-19 E4B was used as the nucleating agent. Table 2 provides the concentrations of the microporous film concentrations, Mullens Burst pressure, Gurley values, and horizontal burn test results, as analyzed pursuant to the method discussed above, for films formed from the compositions of Example 2 and Comparative Example B.

TABLE 2

| | PV-19 E4B as Nucleating Agent | | | | | | |
|---|---|---|---|---|---|---|---|
| | | Mineral | PE-68, | PV-19 | Mullens | Gurley values | Horz. Burn |
| Ex. | PP, wt % | Oil, wt % | wt % | E4B, wt % | Burst, psi | (sec/50 cc) | (no. passed) |
| 2 | 58.96 | 39.00 | 2.00 | 0.040 | 80.0 | 140.0 | 6 of 6 |
| B | 60.96 | 39.00 | 0.00 | 0.040 | 80.0 | 185.0 | 0 of 6 |

The data provided in Table 2 illustrates the waterproof property, breathability, and good flame retardancy exhibited by films formed from the composition of the present invention. In particular, the film formed from the composition of Example 2 had a Mullens burst value of 80 psi and Gurley resistance to airflow of 140 sec/50 cc. The film passed the horizontal burn test 6 out of 6 times. The Gurley resistance and Mullens Burst values indicate that the film formed from the composition of the present invention has a porosity that allows the film to breath while preventing water from passing through the film. The horizontal burn test indicates the film's low level of flammability.

While the waterproof property and breathability of the film of Comparative Example B did not vary greatly from Example 2, the flammability of the films were greatly affected by the amount of flame retardant present in the formulation. As can be seen in Table 2, comparative Example B passed the horizontal burn test 0 out of 6 times, in contrast to Example 2, which passed the horizontal burn test 6 out of 6 times.

### Example 3 and Comparative Examples C and D

To prepare Example 3, polypropylene, HI5-5 concentrate, and CN-2923 were dry blended and then fed into the hopper of a 25 mm twin-screw extruder. Mineral oil was pumped through a mass flowmeter and introduced into the extruder through an injection port in the second zone of a six-zone extruder. The composition was rapidly heated to 260° C. in the extruder to melt mix the components at 150 rpm screw speed after which the temperature was cooled down to and maintained at 204° C. through the remainder of the extruder barrel. The molten composition was pumped from the extruder, through a filter, into a melt pump with a flow rate of 3.63 kg/hr and then via a necktube into and through a coat hanger slit die and cast onto a chrome roll (66° C.) running at 2.1 meters/min. The chrome roll had a knurled pattern on it consisting of 40 raised truncated pyramids per centimeter both axially and radially. A roll of cast film was saved and biaxial stretched off-line 1.7×1.7 using a length orienter maintained at 66° C. and a tenter/stretching oven maintained at 116° C.

Comparative Example C was prepared as in Example 3, except that no CN-2923 was added to the composition and the mineral oil content was increased such that it was 39 wt % of the total composition. Comparative Example D was prepared as in Example 1, except that a different nucleating agent was used. Table 3 provides the concentrations of the microporous film concentrations, Mullens Burst pressure, Gurley values, and horizontal burn test results, as analyzed pursuant to the method discussed above, for films formed from the compositions of Example 3 and Comparative Examples C and D.

TABLE 3

| | HPN-68 and Millad 3988 as Nucleating Agent | | | | | | | | | |
|---|---|---|---|---|---|---|---|---|---|---|
| | | Mineral | PE-68, wt %, | | HPN-68, wt % | | Millad | Mullens | Gurley values | Horz. Burn |
| Ex. | PP, wt % | Oil, wt % | (CN-2923, wt %) | | (HI5-5, wt %) | | 3988, wt % | Burst, psi | (sec/50 cc) | (no. passed) |
| 3 | 54.67 | 37.00 | 2.00 | (3.33) | 0.25 | (5.0) | 0.00 | 40.0 | 11.0 | 6 of 6 |
| C | 56.0 | 39.00 | 0.00 | | 0.25 | (5.0) | 0.00 | 70.0 | 23.0 | 0 of 6 |
| D | 60.93 | 37.00 | 2.00 | | 0.00 | | 0.070 | N/A | N/A | N/A |

The data provided in Table 3 illustrates the waterproof property, breathability, and good flame retardancy exhibited by films formed from the composition of the present invention. In particular, the film formed from the composition of Example 3 had a Mullens Burst value of 40 psi and Gurley resistance to airflow of 11 sec/50 cc. The film passed the horizontal bum test 6 out of 6 times. The Gurley resistance and Mullens Burst values indicate that the film formed from the composition of the present invention has a porosity that allows the film to breath while preventing water from passing through the film. The horizontal bum test indicates the film's low level of flammability.

As with Examples 1 and 2 compared to Comparative Examples A and B, respectively, while the waterproof property and breathability of the film of Comparative Example C did not vary greatly from Example 3, the flammability of the films were greatly affected by the amount of flame retardant present in the formulation. As can be seen in Table 3, the results of the horizontal burn test were greatly affected. Comparative Example C did not pass the horizontal burn test at all, in contrast to Example 3, which passed the horizontal burn test each time.

While Comparative Example D did melt to produce a particle-free cast film, it fouled the heterogeneous nucleation of the Millad 3988, resulting in an extremely weak film that could not be oriented without fracture.

### Example 4 and Comparative Examples E and F

To make Example 4, polypropylene, CN-2923, Irganox 1010, and HI5-5 resin pellets were fed into the hopper of a 40 mm twin-screw extruder. Mineral oil was pumped through a mass flowmeter and introduced into the extruder through an injection port in the third zone of an eight-zone extruder. The composition was rapidly heated to 260° C. in the extruder to melt mix the components at 150 rpm screw speed after which the temperature was cooled down to and maintained at 204° C. through the remainder of the extruder barrel. The molten composition was pumped from the extruder, through a filter, into a melt pump at a flow rate of 10.4 kg/hr and then via a necktube into and through a coat hanger slit die and cast onto a chrome roll (66° C.) turning at 6.9 meters/min. The chrome roll had a knurled pattern on it consisting of 40 raised truncated pyramids per centimeter both axially and radially. The cast film was then stretched in-line 1.7×1.7 using a length orienter maintained at 66° C. and a tenter/stretching oven maintained at 116° C.

Comparatives Examples E and F were prepared as in Example 4, except that no flame retardant was added to the composition and the mineral oil content was increased such that it was 37% of the total composition. In addition, no Irganox was added in Comparative Example E. Table 4 provides the concentrations of the microporous film concentrations, Mullens Burst pressure, Gurley values, and horizontal burn test results, as analyzed pursuant to the methods discussed above, for films formed from the compositions of Example 4 and Comparative Examples E and F.

TABLE 4

| | HPN-68 as Nucleating Agent | | | | | | | | |
|---|---|---|---|---|---|---|---|---|---|
| | | | | | | Mineral | | | |
| | | PE-68, wt % | | Irganox | HPN-68, wt % | Oil conc., | Mullens | Gurley values | Horz. Burn |
| Ex. | PP, wt % | (CN-2923, wt %) | | 1010, wt % | (HI5-5, wt %) | wt % | Burst, psi | (sec/50 cc) | (no. passed) |
| 4 | 51.32 | 5.00 | (8.33) | 0.35 | 0.4 (8.0) | 32.0 | 80.0 | 58.0 | 6 of 6 |
| E | 55.00 | 0.00 | | 0.00 | 0.4 (8.0) | 37.0 | 80.0 | 60.0 | 0 of 6 |
| F | 54.35 | 0.00 | | 0.65 | 0.4 (8.0) | 37.0 | 80.0 | 70.0 | 1 of 6 |

The data provided in Table 4 illustrates the waterproof property, breathability, and good flame retardancy exhibited by films formed from the composition of the present invention. In particular, the film formed from the composition of Example 4 had a Mullens Burst value of 80 psi and Gurley resistance to airflow of 58 sec/50 cc. The film passed the horizontal burn test 6 out of 6 times. The Gurley resistance and Mullens Burst values indicate that the film formed from the composition of the present invention has a porosity that allows the film to breath while preventing water from passing through the film. The horizontal burn test indicates the film's low level of flammability.

The waterproof property and breathability of the films of Comparative Examples E and F were relatively similar to the breathability and porosity of Example 4. However, as can be seen in Table 4, the results of the horizontal burn test were greatly affected by the amount of flame retardant present in the formulation. Comparative Example E did not pass the horizontal burn test at all and Comparative Example F only passed the horizontal burn test once, in contrast to Example 4, which passed the horizontal burn test each time.

### Example 5 and Comparative Example G

The film from Example 4 was heat and pressure bonded inline to a 1.25 ounce polypropylene spunbond, by feeding the film and spunbond into a laminating station equipped with a smooth steel roll and 18% point bond steel patterned roll, both maintained at 138° C. The pressure and line speed to affect the bond was 100 pli and 4.6 m/min, respectively.

Comparative Example G was prepared as in Example 5, but used a film with similar breathability and waterproof properties without the flame retardant additive. Table 5 provides the results of horizontal burn tests on the microporous films, as analyzed pursuant to the method discussed above.

TABLE 5

| Example | Horz. Burn (# passed) |
|---|---|
| 5 | 6 of 6 |
| G | 0 of 6 |

The data provided in Table 5 illustrates the good flame retardancy exhibited by films formed from the composition of the present invention. The laminate of Example 5 passed the horizontal burn test 6 out of 6 times. As can be seen in Table 5, the results of the horizontal burn test are greatly affected by the amount of flame retardant present in the formulation and the lamination process. Comparative Example G did not pass the horizontal bum test at all, in contrast to Example 5, which passed the horizontal burn test each time.

Although the present invention has been described with reference to preferred embodiments, workers skilled in the art will recognize that changes may be made in form and detail without departing from the spirit and scope of the invention.

1. A microporous film comprising:
a crystallizable polymer;
a melting flame retardant additive;
a non-melting nucleating agent; and
a diluent.

2. The microporous film of claim 1, and further comprising a thermal stabilizing agent.

3. The microporous film of claim 2, wherein the thermal stabilizing agent is an antioxidant.

4. The microporous film of claim 1, wherein the polymer constitutes about 40% to 75% by weight of the microporous film, based on the entire weight of the microporous film.

5. The microporous film of claim 1, wherein the polymer is polypropylene or high density polyethylene.

6. The microporous film of claim 1, wherein the melting flame retardant additive constitutes about 1% to about 20% by weight of the microporous film, based on the entire weight of the microporous film.

7. The microporous film of claim 6, wherein the melting flame retardant additive constitutes about 2% to about 6% by weight of the microporous film, based on the entire weight of the microporous film.

8. The microporous film of claim 1, wherein the non-melting nucleating agent constitutes about 0.1% to about 5.0% by weight of the microporous film, based on the entire weight of the microporous film.

9. The microporous film of claim 8, wherein the non-melting nucleating agent constitutes about 0.2% to about 1.0% by weight of the microporous film, based on the entire weight of the microporous film.

10. The microporous film of claim 1, wherein the diluent component constitutes about 25% to 60% by weight of the microporous film, based on the entire weight of the microporous film.

11. The microporous film of claim 10, wherein the diluent component constitutes about 35% to 45% by weight of the microporous film, based on the entire weight of the microporous film.

12. A composition comprising:
a polymer;
a melting flame retardant additive;
a non-melting nucleating agent; and
a diluent.

13. The composition of claim 12, wherein the polymer constitutes about 40% to 75% by weight of the composition, based on the entire weight of the composition.

14. The composition of claim 12, wherein the melting flame retardant additive constitutes about 1% to about 20% by weight of the composition, based on the entire weight of the composition.

15. The composition of claim 14, wherein the melting flame retardant additive constitutes about 2% to about 6% by weight of the composition, based on the entire weight of the composition.

16. The composition of claim 12, wherein the non-melting nucleating agent constitutes about 0.1% to about 5.0% by weight of the composition, based on the entire weight of the composition.

17. The composition of claim 16, wherein the non-melting nucleating agent constitutes about 0.2% to about 1.0% by weight of the composition, based on the entire weight of the composition.

18. The microporous film of claim 12, wherein the diluent component constitutes about 25% to 60% by weight of the microporous film, based on the entire weight of the microporous film.

19. The microporous film of claim 18, wherein the diluent component constitutes about 35% to 45% by weight of the microporous film, based on the entire weight of the microporous film.
